(19) United States
(12) Patent Application Publication
(10) Pub. No.: US 2011/0195769 A1
(43) Pub. Date: Aug. 11, 2011

(54) METHOD AND APPARATUS FOR LIMITING PRIZE LIABILITY IN A GAME OF CHANCE

(76) Inventors: Michael D. Frick, Crawfordville, FL (US); Mark Davis, San Juan, PR (US); Timothy Patrick Jonathan Green, Send Surrey (GB)

(21) Appl. No.: 12/703,973

(22) Filed: Feb. 11, 2010

(51) Int. Cl. A63F 9/24; A63F 13/00

(52) U.S. Cl. 463/17; 463/25; 463/30; 463/40

(57) ABSTRACT

A process generates, with a game of chance entry generation apparatus, a plurality of game of chance entries such that (i) each game of chance entry provides a game of chance player with an opportunity to play the game of chance and (ii) the game of chance provides a plurality of offered non-cash prizes such that a cost in cash incurred by a game of chance operator for a plurality of redeemed non-cash prizes, which is a subset of the plurality of offered non-cash prizes, is less than a fair market value of purchasing the plurality of offered non-cash prizes as a result of the cost in cash incurred by the game of chance operator being calculated on a basis of an estimated redemption of the plurality of offered non-cash prizes being less than a full redemption of the plurality of offered non-cash prizes.

### BACKGROUND

1. Field

This disclosure generally relates to the field of gaming. More particularly, the disclosure relates to a game of chance.

2. General Background

A lottery typically calculates an estimated prize payout for a particular lottery game, which is a projected amount of prizes, typically expressed as a percentage of total expected sales revenue for such game, that the lottery will offer to winners for the expected life of a particular lottery game, or over a given period of time.

Some prizes which the lotteries may offer as part of their prize payout may include non-cash prizes (e.g., merchandise, services, discounts on the purchase of goods or services, coupons, or the like). The lotteries acquire the non-cash prizes from suppliers thereof or their agents (or contract with such suppliers or their agents for such suppliers or their agents to fulfill the delivery of applicable non-cash prizes to redeeming winners on behalf of the lotteries) at no less than the fair market value of such non-cash prizes (and/or for such fulfillment service, where applicable). The term fair market value refers to the lowest cash price (and/or the lowest value of any other consideration, if applicable) which must be paid and/or provided: (i) by a third-party, unrelated purchaser which is purchasing, on the open market and at arms-length, the same non-cash prizes in the same volume as is a lottery, (ii) to suppliers of such non-cash prizes in exchange for obtaining such non-cash prizes from such suppliers (and/or for such fulfillment service, where applicable).

For example, a lottery may decide that sixty percent of the revenue received from lottery ticket sales will be offered to pay out lottery prizes (whether such prizes are cash prizes, non-cash prizes, or some combination of both) that may be redeemed by winners during the life of a particular game.

Over time, the lottery industry trend has been to increase the prize payout as a percentage of sales, thereby decreasing the net retained percentage, which is the percentage of sales that the lotteries are able to retain.

### SUMMARY

In one aspect of the disclosure, a process is provided. The process generates, with a game of chance entry generation apparatus, a plurality of game of chance entries such that (i) each game of chance entry provides a game of chance player with an opportunity to play the game of chance and (ii) the game of chance provides a plurality of offered non-cash prizes such that a cost in cash incurred by a game of chance operator for a plurality of redeemed non-cash prizes, which is a subset of the plurality of offered non-cash prizes, is less than a fair market value of purchasing the plurality of offered non-cash prizes as a result of the cost in cash incurred by the game of chance operator being calculated on a basis of an estimated redemption of the plurality of offered non-cash prizes being less than a full redemption of the plurality of offered non-cash prizes. Further, the process operates, with one or more game operation processors, the game of chance to determine one or more winning outcomes.

In another aspect of the disclosure, a computer program product is provided. The computer program product includes a computer useable medium having a computer readable program. The computer readable program when executed on a computer causes the computer to generate, with a game of chance entry generation apparatus, a plurality of game of chance entries such that (i) each game of chance entry provides a game of chance player with an opportunity to play the game of chance and (ii) the game of chance provides a plurality of offered non-cash prizes such that a cost in cash incurred by a game of chance operator for a plurality of redeemed non-cash prizes, which is a subset of the plurality of offered non-cash prizes, is less than a fair market value of purchasing the plurality of offered non-cash prizes as a result of the cost in cash incurred by the game of chance operator being calculated on a basis of an estimated redemption of the plurality of offered non-cash prizes being less than a full redemption of the plurality of offered non-cash prizes. Further, the computer readable program when executed on the computer causes the computer to operate, with one or more game operation processors, the game of chance to determine one or more winning outcomes.

In yet another aspect of the disclosure, a system is provided. The system includes a game of chance entry generation apparatus that generates a plurality of game of chance entries such that (i) each game of chance entry provides a game of chance player with an opportunity to play the game of chance and (ii) the game of chance provides a plurality of offered non-cash prizes such that a cost in cash incurred by a game of chance operator for a plurality of redeemed non-cash prizes, which is a subset of the plurality of offered non-cash prizes, is less than a fair market value of purchasing the plurality of offered non-cash prizes as a result of the cost in cash incurred by the game of chance operator being calculated on a basis of an estimated redemption of the plurality of offered non-cash prizes being less than a full redemption of the plurality of offered non-cash prizes. Further, the system includes one or more game operation processors that operate the game of chance to determine one or more winning outcomes.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a game of chance prize liability limitation system.

FIG. 2A illustrates an expanded view of the game operator server illustrated in FIG. 1.

FIG. 2B illustrates an alternative configuration to FIG. 2A such that the game operator server performs game management functions, but the game operation functions are performed by the game of chance entry generation apparatus.

FIG. 3 illustrates a prize structure with offered non-cash prizes.

FIG. 4 illustrates an overredemption structure for the prize structure with non-cash prizes illustrated in FIG. 3.

FIG. 5 illustrates a process that may be utilized to cap the prize liability of the game of chance operator.

FIG. 6 illustrates a game of chance prize liability limitation and third party sponsorship system.

FIG. 7 illustrates a prize structure with cash prizes and non-cash prizes.

FIG. 8 illustrates a block diagram of a station or system that provides limits on prize liability.

### DETAILED DESCRIPTION

A method and apparatus are disclosed that limit liability in a game of chance. By offering a plurality of non-cash prizes, a game of chance operator can estimate a low redemption rate, i.e., the number of redemptions of prizes out of the total number of prize winners. For example, the game of chance operator may estimate that only ten percent of non-cash prizes won will be redeemed. The game of chance operator bases such an estimate on the assumption that a smaller percentage of non-cash prize winners actually redeem their prizes in contrast with an offering of cash prizes, which may have a much higher prize redemption rate.

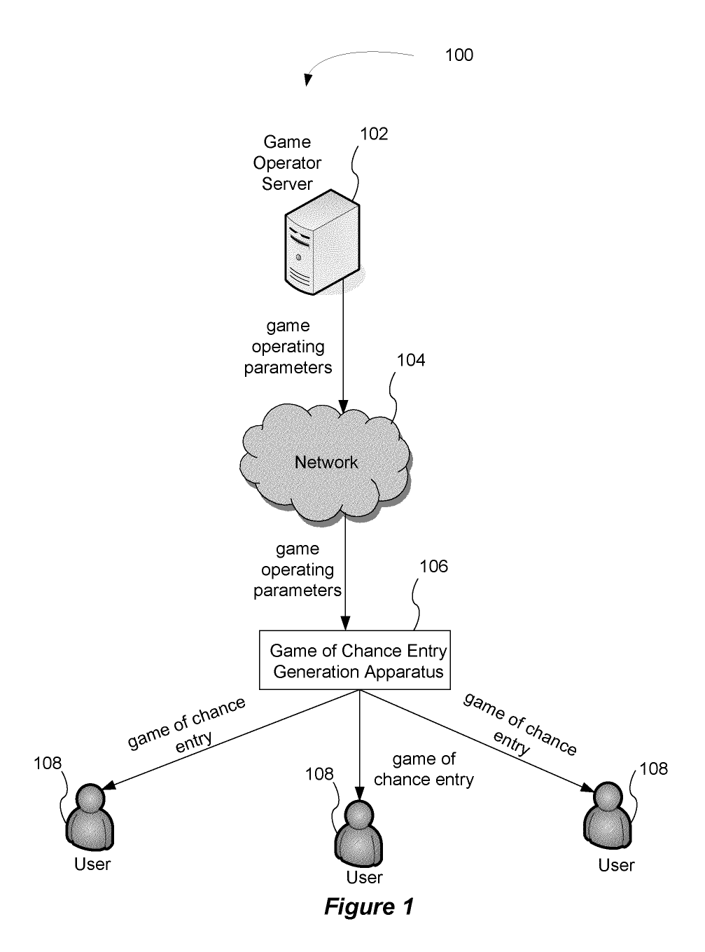

FIG. 1 illustrates a game of chance prize liability limitation system 100. The game of chance prize liability limitation system 100 has a game operator server 102. In one embodiment, the game operator server 102 is a computing system that is utilized by a game of chance operator to manage operations of the game of chance. The game operator server has a game management processor that establishes the game of chance. The establishment of the game of chance may involve storage of the information regarding the game of a chance in a data repository. For example, prize structure data and prize liability limitation data may be stored. Further, the establishment of the game of chance may involve configuring game operating parameters such as game play indicia, how the game is to be played, etc. In one embodiment, the game operator server communicates one or more game operating parameters through a network 104, which then communicates the one or more game operating parameters to a game of chance entry generation apparatus 106. The game of chance entry generation apparatus 106 then generates game of chance entries for sale to a plurality of users 108. The term game of chance entry is intended to allow for play in the game of chance. Accordingly, a paper ticket, electronic ticket, electronic display, or the like may be utilized to communicate to the player that the player may play the game of chance. Further, in one embodiment, the game of chance entry indicates a plurality of game play indicia that the player utilizes to play the game of chance. The game of chance entry apparatus 106 may be a terminal having a ticket printer if the game of chance entries are tickets that are to be printed. Alternatively, the game of chance entry apparatus 106 may have a video display if the game of chance entry is an electronic ticket. In one embodiment, the game of chance is played through the Internet. Further, a wireless communication device may be utilized to purchase and/or play the game of chance through a network such as the Internet. The wireless communication device may be a cell phone, smart phone, personal digital assistant (“PDA”), portable media player, mp3 player, or the like.

In one embodiment, the game operator server 102 establishes the game of chance, but does not send the one or more game operating parameters through the network 104 to the game of chance entry generation apparatus 106. For example, the game of chance entry generation apparatus 106 may have the one or more game operating parameters programmed directly into the game of chance entry generation apparatus 106. Alternatively, the one or more game operating parameters may be manually entered into the game of chance entry generation apparatus by a retailer at a point of sale location.

In one embodiment, the game of a chance is a game for which a player has a chance at winning or not winning a prize. The game of chance may be a lottery game such as an instant lottery game, a drawing based game, a terminal generated outcome lottery game, or the like. In one embodiment, the game of chance is an instant lottery game such that play indicia for a game of chance player are predetermined and generated prior to purchase at a point of sale. In another embodiment, the game of chance is a terminal generated game such that play indicia for a game of chance player are generated at a terminal at a point of sale. In yet another embodiment, the game of chance is an interactive game that, through a computing device, is electronically purchased and electronically played by a game of chance player. In another embodiment, the game of chance is a video lottery terminal game. In yet another embodiment, the game of chance is a stand-alone game. In another embodiment, the game of chance is an add-on game to a distinct game, which may be a game of chance or a game other than a game of chance. Further, the game of chance may be bundled with one or more other games, which may be one or more games of chance, games other than games of chance, or a combination of both types of games.

In another embodiment, the game of chance is a game for which a player has a chance at winning different non-cash prizes with different values. For example, the game of chance may be a game in which every ticket is a winning ticket, but the chance is directed towards what type of prize a player may win. An example of such a game may be a sweepstakes. The methodology described herein is applicable to a game where every ticket is a winner based on the assumption of a low redemption rate for non-cash prizes.

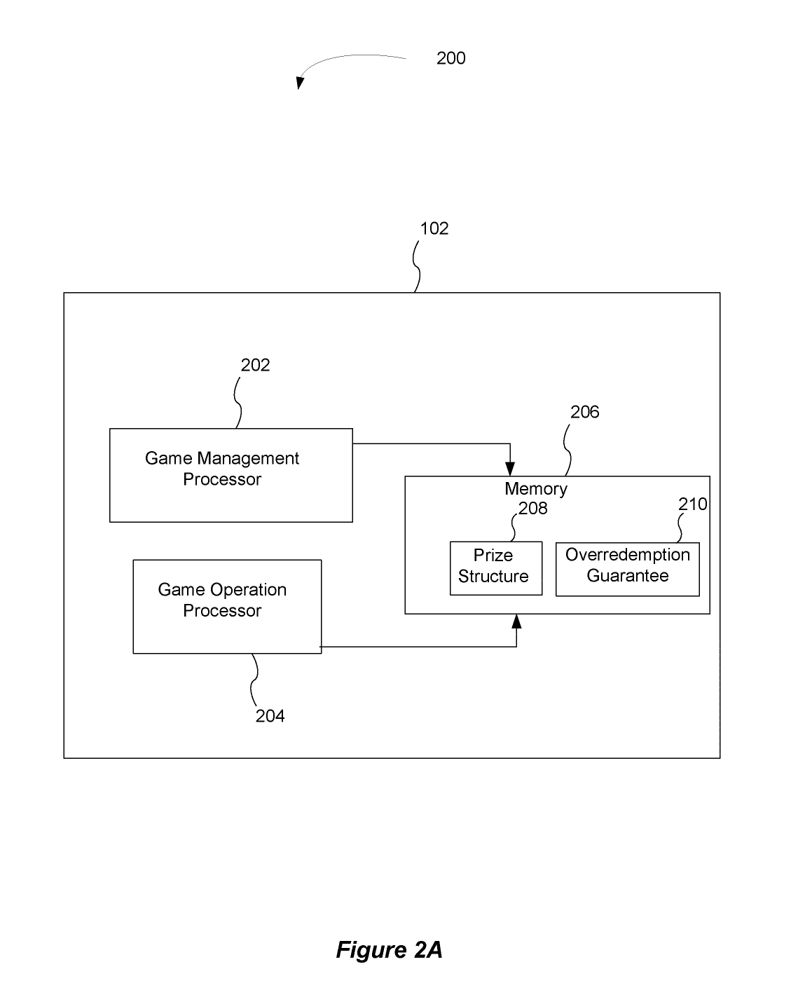

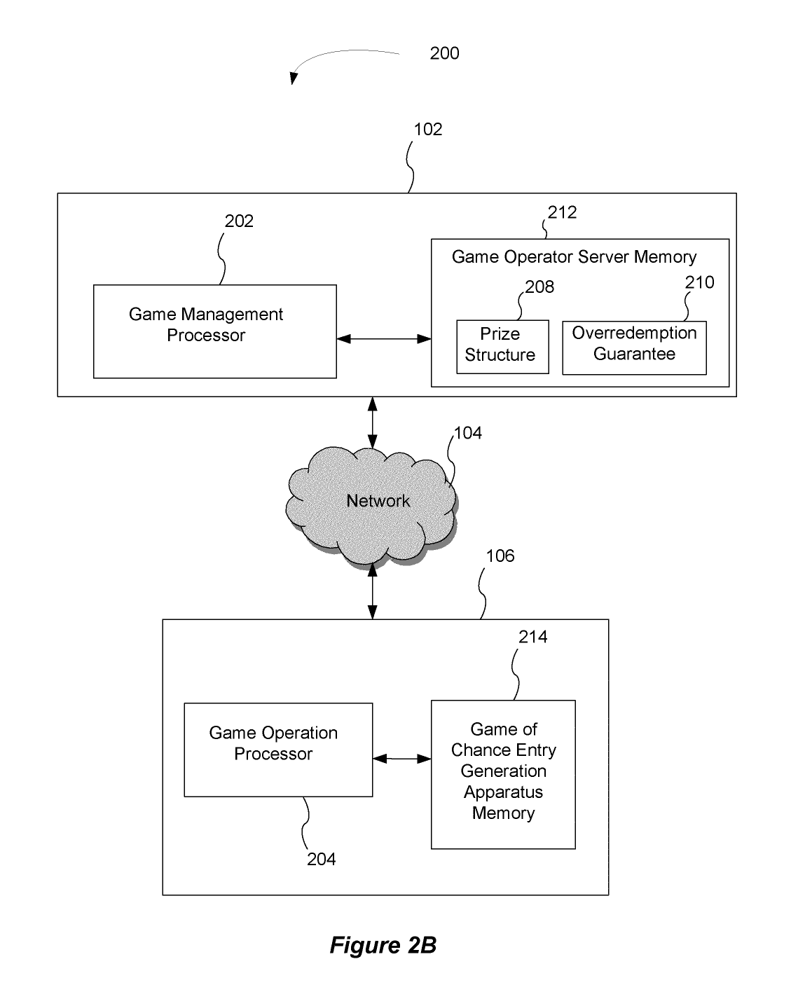

FIG. 2A illustrates an expanded view of the game operator server 102 illustrated in FIG. 1. The game operator server 102 has a game management processor 202 that processes instructions for the establishment of the game of chance and a game operation processor 204 that executes the game of chance. As an example, the game operation processor 204 may randomly generate winning outcomes for the game of chance 204. Both the game management processor 202 and the game operation processor 204 may utilize a memory 206, or may alternatively utilize separate memories. An example of the game operator server 102 is a server that is operated by a lottery that has a drawing based game. The lottery establishes a lottery game with the game operator server 102 and draws a random winning outcome with the game operation processor 204. The memory 206 may store a prize structure 208 and an overredemption guarantee 210. In another embodiment, the memory 206 may additionally store one or more game operating parameters.

FIG. 2B illustrates an alternative configuration to FIG. 2A such that the game operator server 102 performs game management functions, but the game operation functions are performed by the game of chance entry generation apparatus 106. The game operator server 102 may have the game management processor 202 and a game operator server memory 212 to manage the game of chance. The game operator server memory 212 may store the prize structure 208 and where applicable, an overredemption guarantee 210. The game of chance entry generation apparatus memory 214 may store the one or more game operating parameters. In another embodiment, the game management processor 202 stores the one or more game operating parameters in addition to the game of chance entry generation apparatus memory 214 storing the one or more game operating parameters so that the game management processor 202 is aware of how the game is being operated by the game of chance entry generation apparatus 106.

An example of this configuration is a lottery server that establishes a lottery game and communicates with a plurality of terminals that each randomly generates winning outcomes independently of the lottery server. In one embodiment, the lottery server communicates with the plurality of terminals through the network 104. Each of the terminals has the game operation processor to operate the game of chance independently of the game operator server 102 once the game operator server has established the game of chance. In one embodiment, the game of chance entry generation apparatus 106 communicates back through the network 104 with the game operator server 102 to provide data on winning outcomes and/or for verification purposes.

An example of a terminal is a game of chance entry generation apparatus 106. A terminal located at a point of sale location may print a lottery ticket, but may also randomly determine the play indication of a player, the winning outcome of a player, and/or both. Alternatively, the game of chance entry generation apparatus 106 may be separate from a game play terminal. For example, a player may purchase a game of chance entry at a game of chance entry generation apparatus 106 such as a kiosk and play the game of chance at a game play terminal.

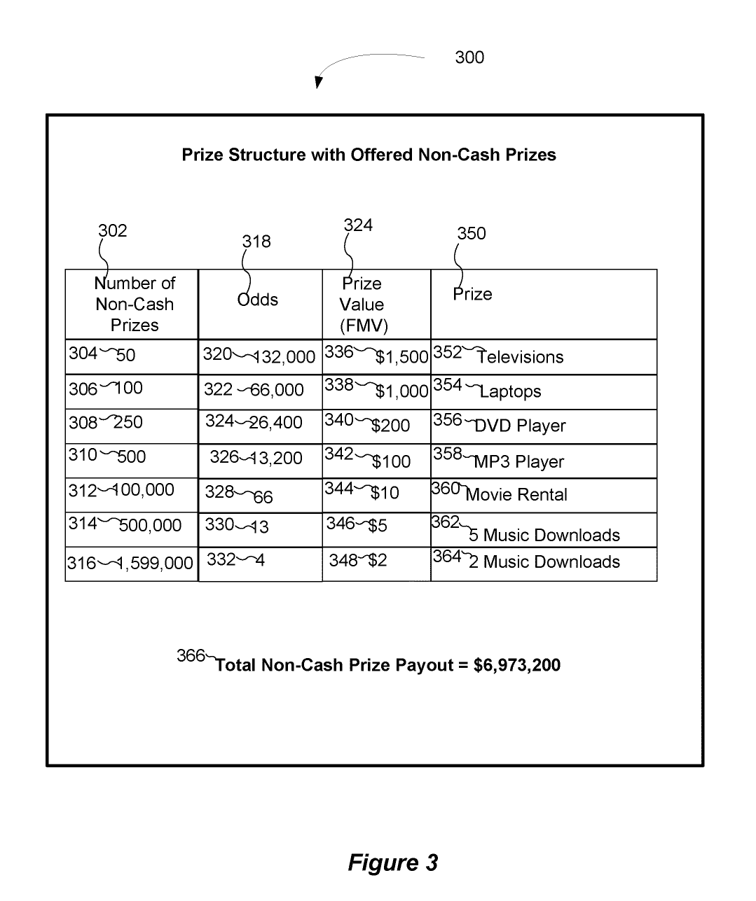

FIG. 3 illustrates a prize structure with offered non-cash prizes 300. The prize structure with non-cash prizes 300 is utilized by the game management processor 202. A number of non-cash prizes field 302 indicates the number of offered non-cash prizes. Further, an odds field 318 indicates the odds of winning an offered prize. In addition, a prize value field 324 indicates the fair market value of the offered prize. Finally, a prize field 350 indicates the offered prize. A first quantity 304 of fifty televisions 352 each having a first prize value of one thousand five hundred dollars have an odds of one in one hundred thirty two thousand of being won. Further, a second quantity 306 of one hundred laptops 354 each having a second prize value of one thousand dollars have an odds of one in sixty six thousand of being won. In addition, a third quantity 308 of two hundred fifty DVD players 356 each having a third prize value of two hundred dollars have an odds of one in twenty six thousand four hundred of being won. A fourth quantity 310 of five hundred MP3 players 358 each having a fourth prize value of one hundred dollars have an odds of one in thirteen thousand two hundred of being won. Further, a fifth quantity 312 of one hundred thousand movie rentals 360 each having a fifth prize value of ten dollars have an odds of one in sixty six of being won. In addition, a sixth quantity 314 of five hundred thousand music download packages with five music downloads 362 such that each package has a sixth prize value of five dollars and an odds of one in thirteen of being won. A seventh quantity 316 of one million five hundred ninety nine thousand music download packages with two music downloads 364 such that each package has a seventh prize value of two dollars and an odds of one in four of being won. If all prizes were won and redeemed, the total prize payout 366 would be six million nine hundred seventy three two hundred dollars.

The prize structure with non-cash prizes 300 illustrated herein is for illustrative purposes only. For example, merchandise prizes are shown. However, other types of non-cash prizes may be offered in place of or in addition to merchandise prizes. Further, the number and value of the prizes may be different from the illustrated example. In addition, the odds may be different.

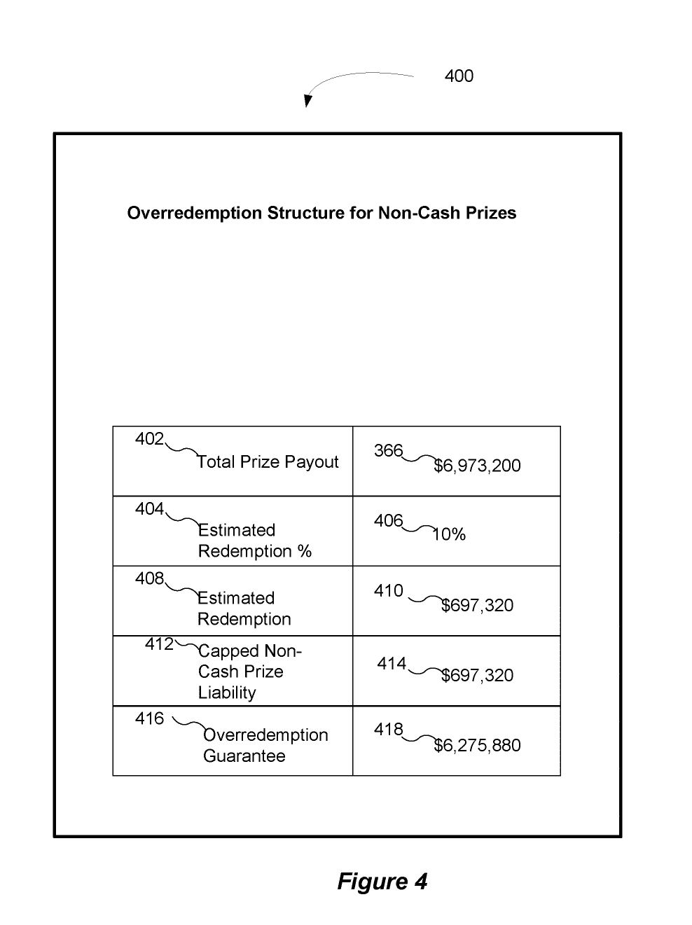

FIG. 4 illustrates an overredemption structure 400 for the prize structure with non-cash prizes 300 illustrated in FIG. 3. In a total prize payout field 402, the total prize payout 366 is indicated. An estimated redemption percentage field 404 indicates an estimated redemption percentage 406 of ten percent. This estimate is based on a relatively low redemption rate in comparison with cash prizes as game of chance players typically redeem non-cash prizes less frequently than cash prizes. Accordingly, an estimated redemption filed 408 indicates an estimated redemption 410 is six hundred ninety seven thousand three hundred twenty dollars. A capped non-cash prize liability field 412 indicates a capped non-cash prize liability 414 of six hundred ninety seven three hundred twenty dollars. As a result, the game of chance operator does not have to pay more than six hundred ninety seven three hundred twenty dollars in prize redemption. If the prize redemption is less than six hundred ninety seven three hundred twenty dollars, the game of chance operator pays less than six hundred ninety seven three hundred twenty dollars. If the prize redemption is equal to six hundred ninety seven three hundred twenty dollars, the game of chance operator pays six hundred ninety seven three hundred twenty dollars. In the instance where the prize redemption exceeds the estimated redemption percentage 406, the excess amount is paid by an overredemption guarantor. In other words, the game of chance operator obtains, directly or indirectly, an overredemption guarantee 416, which is indicated by an overredemption guarantee 416, for the difference between the total prize payout 366 and the estimated redemption 406. For example, an overredemption guarantee 418 may be obtained for an amount of six million two hundred seventy five thousand eight hundred eighty dollars, which is the difference between six million nine hundred seventy three thousand two hundred and six hundred ninety seven thousand three hundred twenty. In one embodiment, a total potential prize distribution of the plurality of offered non-cash prizes is greater than total potential sales of the plurality of game of chance entries.

The overredemption guarantee may be a contract, a third party fulfillment contract, insurance, a letter of credit, a bond, or any combination thereof. In one embodiment, the overredemption guarantee is provided by a third party entity. In one embodiment, the game of chance operator incurs a cost in cash for a plurality of redeemed non-cash prizes, which is a subset of the plurality of offered non-cash prizes, that is less than a fair market value of purchasing the plurality of offered non-cash prizes as a result of the cost in cash incurred by the game of chance operator being calculated on a basis of an estimated redemption of the plurality of offered non-cash prizes being less than a full redemption of the plurality of offered non-cash prizes. In yet another embodiment, an entity other than the game of chance operator incurs the cost in cash for a plurality of redeemed non-cash prizes in exchange for a fee from the game of chance operator. In yet another embodiment, the game of chance is established with a third party sponsor in addition to the game of chance operator. In this configuration, a sum of the cost in cash incurred by the game of chance operator for a plurality of redeemed non-cash prizes plus a fair market value of advertising, promotional, and other consideration provided by the game of chance operator to the third party sponsor is less than the fair market value of purchasing the plurality of offered non-cash prizes as a result of the cost in cash incurred by the game of chance operator for the plurality of redeemed non-cash prizes being calculated on a basis of the estimated redemption of the plurality of offered non-cash prizes being less than the full redemption of the plurality of offered non-cash prizes. The cost in cash incurred by the game of chance operator for a plurality of redeemed non-cash prizes may be zero or a portion of the cost in cash incurred for a plurality of redeemed non-cash prizes, with the remainder being incurred by the third party sponsor.

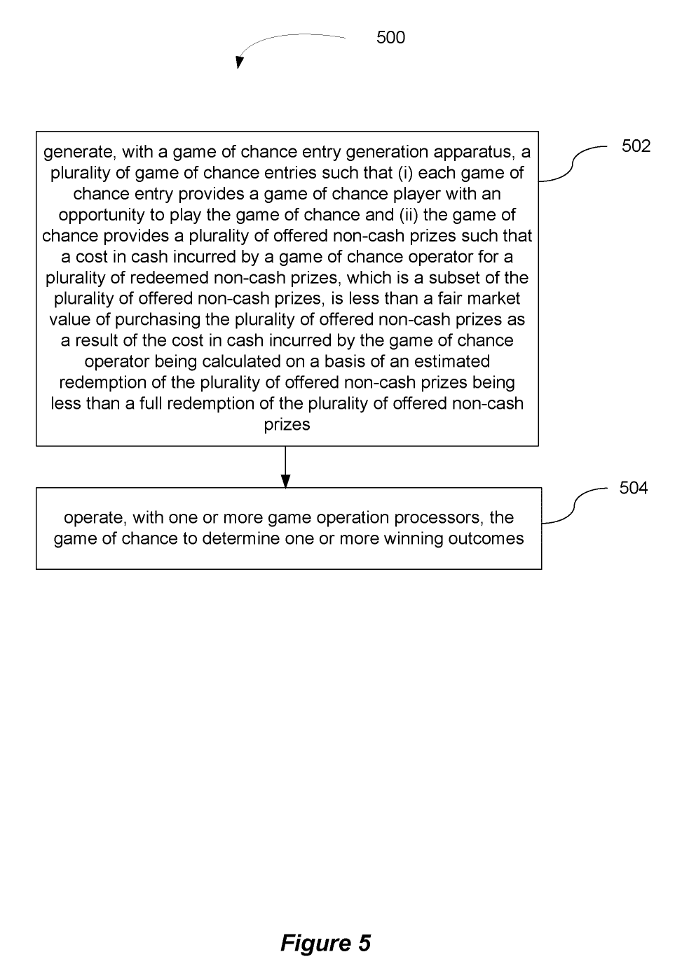

FIG. 5 illustrates a process 500 that may be utilized to cap the prize liability of the game of chance operator. At a process block 502, the process 500 generates, with a game of chance entry generation apparatus, a plurality of game of chance entries such that (i) each game of chance entry provides a game of chance player with an opportunity to play the game of chance and (ii) the game of chance provides a plurality of offered non-cash prizes such that a cost in cash incurred by a game of chance operator for a plurality of redeemed non-cash prizes, which is a subset of the plurality of offered non-cash prizes, is less than a fair market value of purchasing the plurality of offered non-cash prizes as a result of the cost in cash incurred by the game of chance operator being calculated on a basis of an estimated redemption of the plurality of offered non-cash prizes being less than a full redemption of the plurality of offered non-cash prizes. Further, at a process block 504, the process 500 operates, with one or more game operation processors, the game of chance to determine one or more winning outcomes. The determination may be a random generation from a quantity of outcomes that is not predetermined, a random generation from a predetermined finite quantity of winning outcomes (e.g., a scrambling of a predetermined quantity of winning numbers), a predetermined outcome (e.g., a winning outcome after a predetermined number of game of chance entries have been sold), or any other type of methodology to select a winner.

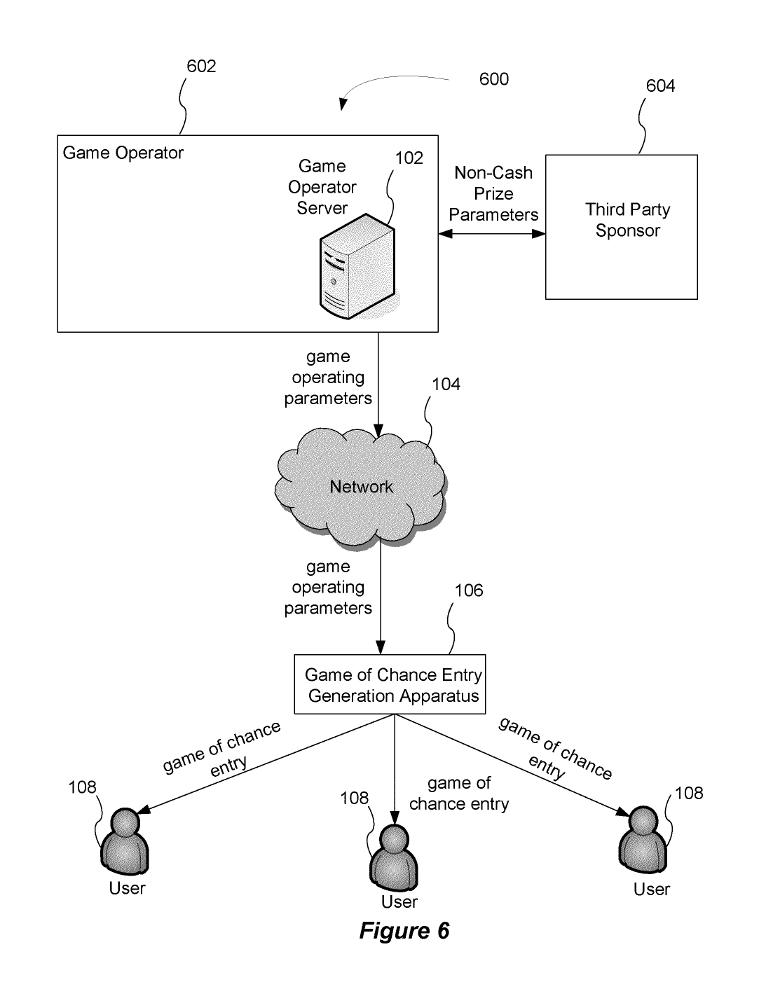

FIG. 6 illustrates a game of chance prize liability limitation and third party sponsorship system 600. The game of chance prize liability limitation and third party sponsorship system 600 has a third party sponsor 604 that interacts with a game of chance operator 602. The third party sponsor 604 is a third party which bears some or all of the cost in cash that would otherwise be incurred by the game of chance operator 602 for a plurality of redeemed non-cash prizes in exchange for the third party receiving advertising, promotional, and/or other consideration from the game of chance operator 602. In one embodiment, the third party sponsor 604 and the game of chance operator 602 exchange non-cash prize parameters. For example, the third party sponsor 604 may be involved in the supplying of the non-cash prizes and may offer to provide an amount of non-cash prizes. The third party sponsor 604 may then decide to obtain an overredemption guarantee to address the possible outcome of the redemption rate exceeding the estimated redemption rate. Accordingly, the game of chance operator 602 is able to offer the non-cash prizes without a non-cash prize cost or with a reduced non-cash prize cost to the game of chance operator 602. Alternatively, the third party sponsor 604 may choose to forgo obtaining an overredemption guarantee. For example, the third party sponsor 604 may be involved in the supplying of the prizes and may choose to assume the risk of the prize redemption rate exceeding the estimated prize redemption. The third party sponsor 604 may contract with a fulfillment service provider to fulfill the obligation of the third party sponsor 604 to deliver the redeemed non-cash prizes to redeeming winners.

In one embodiment, the third party sponsor 604 provides the non-cash prizes to the game of chance operator 602 in exchange for the game of chance operator 602 displaying, with a display generation apparatus, an indicator associated with the third party sponsor on one or more game entries for the game of chance. For example, a logo of the third party sponsor may be placed on a lottery ticket. As a result, the third party sponsor 604 receives advertising and promotional consideration. A value can be determined for the advertising and promotional consideration. In other words, the offering of the non-cash prizes with the name and/or logo of the third party sponsor 604 in and of itself is advertising and promotional consideration factored into the value of the non-cash prizes. Even without the indicator being displayed, the third party sponsor 604 may receive other advertising, promotional, and/or other consideration for the non-cash prizes being offered. In one embodiment, the sum of the cost in cash incurred by the game of chance operator for a plurality of redeemed non-cash prizes plus a fair market value of advertising, promotional, and other consideration provided by the game of chance operator to the third party sponsor is less than the fair market value of the plurality of offered non-cash prizes as a result of the cost in cash incurred by the game of chance operator for the plurality of redeemed non-cash prizes being calculated on a basis of the estimated redemption of the plurality of offered non-cash prizes being less than the full redemption of the plurality of offered non-cash prizes.

In another embodiment, the third party sponsor 604 is not involved in the supplying of the non-cash prizes. Accordingly, the third party sponsor 604 may receive advertising, promotional and/or other consideration from the game of chance operator 602 in exchange for providing the cost in cash which would otherwise be incurred by a game of chance operator for a plurality of redeemed non-cash prizes.

In yet another embodiment, the third party sponsor 604 pays for part of the cost in cash of the redeemed non-cash prizes and the game of chance operator 602 pays for the remaining part of the cost in cash of the redeemed non-cash prizes. Accordingly, both the third party sponsor 604 and the game of chance operator 602 may obtain an overredemption guarantee to address the possibility of the actual redeemed non-cash prizes exceeding the estimated redeemed non-cash prizes.

The display generation apparatus may be a ticket printer that prints the logo of the third party sponsor on a paper ticket. Alternatively, the display generation apparatus may be a video display that displays the logo of the third party sponsor. As an example, the video display may be part of a video terminal at which the game of chance lottery entry is purchased. The video display may also be a video monitor located at a point of sale location so that a purchaser sees the logo of the third party sponsor as the player is receiving a paper ticket. Further, the display generation apparatus may be a display device such as a computer monitor, television, smart phone display screen, etc. that displays an advertisement on a web site.

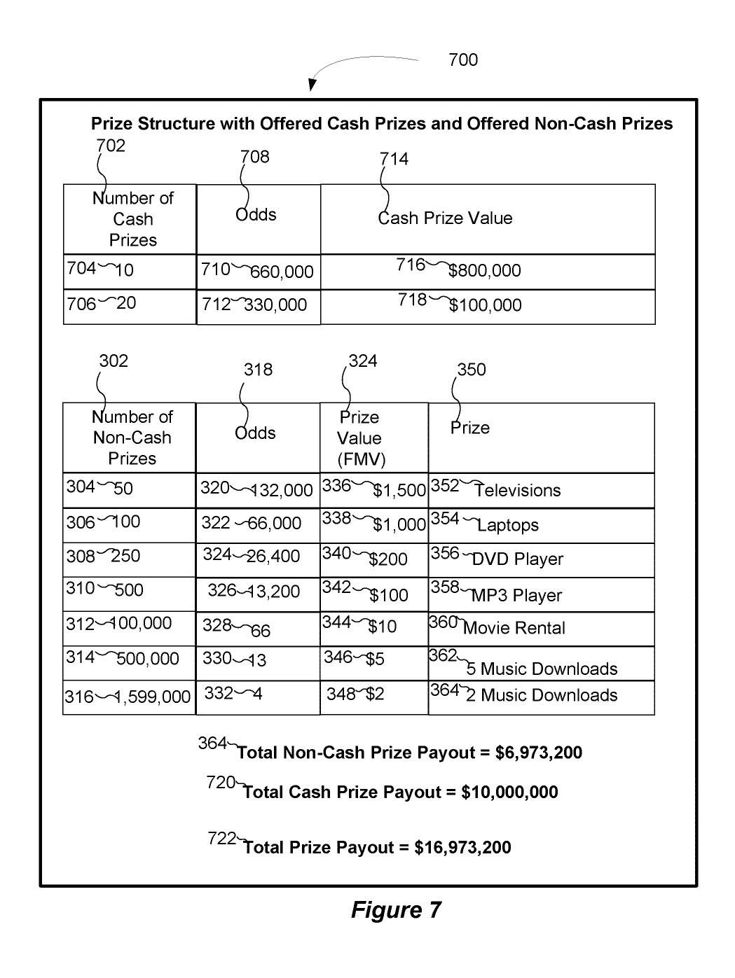

FIG. 7 illustrates a prize structure 700 with offered cash prizes and offered non-cash prizes. The prize structure 700 with offered cash prizes and offered non-cash prizes is a game of chance parameter utilized by the game management processor 202. A number of cash prizes field 702 indicates the number of offered cash prizes. Further, an odds field 708 indicates the odds of winning a prize. In addition, a prize value field 714 indicates the value of the prize. A first cash prize quantity 704 of ten cash prizes each having a first cash prize value 716 of eight hundred thousand dollars have an odds 710 of one in six hundred sixty thousand of being won. Further, a second cash prize quantity 706 of twenty cash prizes each having a second cash prize value 718 of one hundred thousand dollars have and odds an odds 712 of one in three hundred thirty thousand of being won. As a result, the total cash prize payout 720 may potentially be ten million dollars if all the cash prizes are won and redeemed. As a larger portion of the cash prizes than non-cash prizes are typically redeemed, the overredemption guarantee is provided only for the non-cash prizes, not for the cash prizes. In yet another embodiment, the overredemption guarantee may also apply to one or more of the offered cash prizes. The total prize payout 722 is potentially sixteen million dollars nine hundred seventy three thousand two hundred dollars if all offered cash prizes and offered non-cash prizes are won and redeemed. As a result, the game of chance operator now may provide a game of chance having a total potential payout of sixteen million dollars nine hundred seventy three thousand two hundred dollars for a game for which the game of chance operator 602 has prize liability which is less than the sum of the offered cash prizes plus the value of the offered non-cash prizes. In one embodiment, a total potential prize distribution of a plurality of offered non-cash prizes and a plurality of offered cash prizes is greater than total potential sales of the plurality of game of chance entries.

The prize structure with cash prizes and non-cash prizes 700 illustrated herein is for illustrative purposes only. For example, merchandise prizes are shown. However, other types of non-cash prizes may be offered in place of or in addition to merchandise prizes. Further, the number and value of the cash prizes and non-cash prizes may be different from the illustrated example. In addition, the odds may be different.

The prize structure 700 with offered cash prizes and offered non-cash prizes may be utilized with the game of chance prize liability limitation and third party sponsorship system 600. The game of chance operator 602 may incur no cost or partial cost for the redeemed non-cash prizes as a result of obtaining an overredemption guarantee and/or the third party sponsor 604 also obtaining an overredemption guarantee. Accordingly, the game of chance operator 602 is still able to provide a game with a total amount of offered prizes that may be greater than sales.

When a third party sponsor 604 is involved in any of the configurations provided herein, the third party sponsor 604 may arrange for prize fulfillment directly or indirectly. For example, if the third party sponsor 604 is involved in supplying a non-cash prize, the third party sponsor 604 may provide the non-cash prize directly to a winner. Alternatively, the third party sponsor 604 may provide the non-cash prize to the game of chance operator 602 or to a fulfillment service to provide to the winner.

In one embodiment, one game of chance is utilized for both non-cash and cash prizes. In other words, different types of winning outcomes provides non-cash and/or cash prizes. In an alternative embodiment, multiple games of chance may be utilized for both non-cash and cash prizes. For example, a first game of chance may be utilized for the non-cash prizes and a second game of chance may be utilized for the cash prizes. Any of the configurations described herein may be utilized for any number or types of games of chance with non-cash and cash prizes.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network.

A computer is herein intended to include any device that has a general, multi-purpose or single purpose processor as described above. For example, a computer may be a lottery terminal, a kiosk, a vending machine, a set top box (“STB”), cell phone, portable media player, or the like.

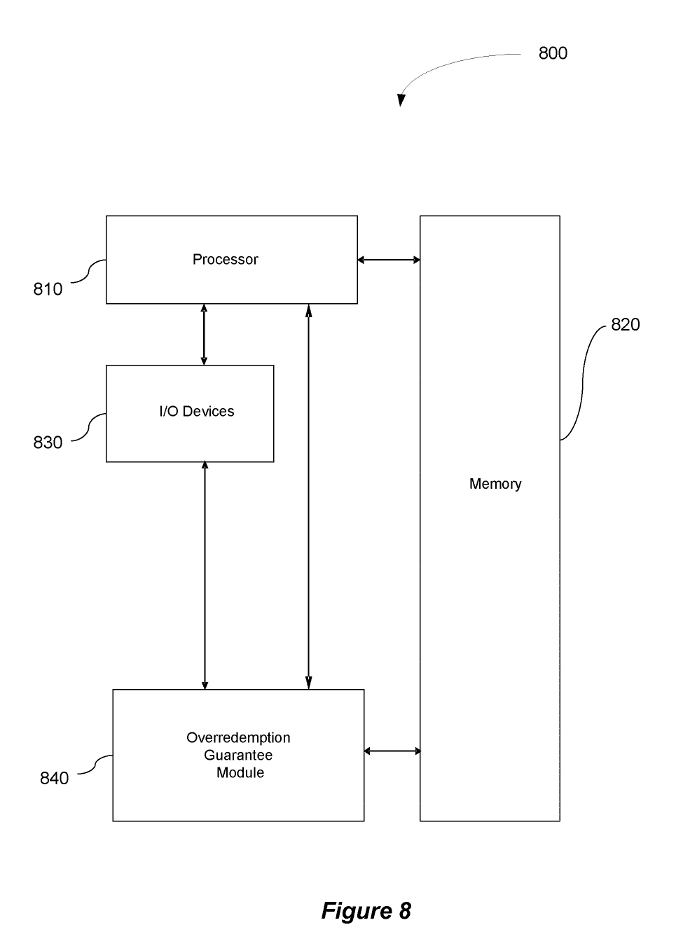

FIG. 8 illustrates a block diagram of a station or system 800 that provides limits on prize liability. In one embodiment, the station or system 800 is implemented utilizing a general purpose computer or any other hardware equivalents. Thus, the station or system 800 comprises a processor 810, a memory 820, e.g., random access memory (“RAM”) and/or read only memory (ROM), an overredemption guarantee module 840, and various input/output devices 830, (e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the overredemption guarantee module 840 may be implemented as one or more physical devices that are coupled to the processor 810. For example, the overredemption guarantee module 840 may include a plurality of modules. Alternatively, the overredemption guarantee module 840 may be represented by one or more software applications (or even a combination of software and hardware, e.g., using application specific integrated circuits (ASIC)), where the software is loaded from a storage medium, (e.g., a magnetic or optical drive, diskette, or non-volatile memory) and operated by the processor in the memory 820 of the computer. As such, the overredemption guarantee module 840 (including associated data structures) of the present disclosure may be stored on a computer readable medium, e.g., RAM memory, magnetic or optical drive or diskette and the like.

The station or system 800 may be utilized to implement any of the configurations herein. For example, the processor 810 may be utilized to establish a game, operate a game, perform calculations, or the like.

A virtual device may be utilized to provide any of the games provided herein. For example, a virtual lottery ticket may be sold rather than a paper ticket. For instance, a player may be able to purchase an electronic version of a ticket through a computing device such as a computer, laptop, kiosk, cell phone, smart phone, personal digital assistant, or the like.

It is understood that the processes and systems described herein may also be applied in other types of processes and systems. Those skilled in the art will appreciate that the various adaptations and modifications of the embodiments of the processes and systems described herein may be configured without departing from the scope and spirit of the present processes and systems. Therefore, it is to be understood that, within the scope of the appended claims, the present processes and systems may be practiced other than as specifically described herein.

1. A method comprising:
generating, with a game of chance entry generation apparatus, a plurality of game of chance entries such that (i) each game of chance entry provides a game of chance player with an opportunity to play the game of chance and (ii) the game of chance provides a plurality of offered non-cash prizes such that a cost in cash incurred by a game of chance operator for a plurality of redeemed non-cash prizes, which is a subset of the plurality of offered non-cash prizes, is less than a fair market value of purchasing the plurality of offered non-cash prizes as a result of the cost in cash incurred by the game of chance operator being calculated on a basis of an estimated redemption of the plurality of offered non-cash prizes being less than a full redemption of the plurality of offered non-cash prizes; and
operating, with one or more game operation processors, the game of chance to determine one or more winning outcomes.

2. The method of claim 1, wherein the game of chance has a third party overredemption guarantee that caps the cost in cash incurred by the game of chance operator for the plurality of redeemed non-cash prizes at a cost that is less than the fair market value of purchasing the plurality of offered non-cash prizes.

3. The method of claim 2, wherein the overredemption guarantee is a contract.

4. The method of claim 2, wherein the overredemption guarantee is a third party fulfillment contract.

5. The method of claim 2, wherein the overredemption guarantee is an insurance policy.

6. The method of claim 2, wherein the overredemption guarantee is a bond.

7. The method of claim 2, wherein the overredemption guarantee is a letter of credit.

8. The method of claim 2, wherein the overredemption guarantee is a combination selected from the group consisting of a contract, an insurance policy, a bond, and a letter of credit.

9. The method of claim 1, wherein the fair market value of purchasing the plurality of offered non-cash prizes is the lowest available cost in cash for an unrelated third party purchaser buying, in an arms-length transaction, the plurality of offered non-cash prizes in the same volume as the game of chance operator.

10. The method of claim 1, wherein the game of chance is established without a third party sponsor.

11. The method of claim 1, wherein the game of chance is established with a third party sponsor.

12. The method of claim 11, wherein a sum of the cost in cash incurred by the game of chance operator for a plurality of redeemed non-cash prizes plus a fair market value of advertising, promotional, and other consideration provided by the game of chance operator to the third party sponsor is less than the fair market value of purchasing the plurality of offered non-cash prizes as a result of the cost in cash incurred by the game of chance operator for the plurality of redeemed non-cash prizes being calculated on a basis of the estimated redemption of the plurality of offered non-cash prizes being less than the full redemption of the plurality of offered non-cash prizes.

13. The method of claim 11, further comprising displaying, with a display generation apparatus, an indicator associated with the third party sponsor on one or more game entries for the game of chance.

14. The method of claim 11, wherein the third party sponsor has involvement in supplying the plurality of redeemed non-cash prizes.

15. The method of claim 11, wherein the third party sponsor is a sponsor of the plurality of redeemed non-cash prizes without having involvement in the supplying of the plurality of redeemed non-cash prizes.

16. The method of claim 1, wherein a total potential prize distribution of the plurality of offered non-cash prizes is greater than total potential sales of the plurality of game of chance entries.

17. The method of claim 1, wherein the game of chance also has a plurality of cash prizes.

18. The method of claim 17, wherein a total potential prize distribution of a plurality of offered non-cash prize distributions and a plurality of offered cash prize distributions is greater than total potential sales of the plurality of game of chance entries.

19. The method of claim 17, wherein a quantity of the plurality of game of chance entries available for sale is fixed such that total potential sales of the plurality of game of chance entries is calculated according to a known quantity.

20. The method of claim 17, wherein a quantity of the plurality of game of chance entries available for sale is variable such that total potential sales of the plurality of game of chance entries is calculated according to an estimated quantity.

21. The method of claim 1, wherein the game of chance is a lottery game.

22. The method of claim 21, wherein the game of chance is an instant lottery game such that play indicia for a game of chance player are predetermined and generated prior to purchase at a point of sale.

23. The method of claim 21, wherein the game of chance is a terminal generated game such that play indicia for a game of chance player are generated at a terminal at a point of sale.

24. The method of claim 21, wherein the game of chance is an interactive game that, through a computing device, is electronically purchased and electronically played by a game of chance player.

25. The method of claim 21, wherein the game of chance is electronically purchased by a player through the Internet.

26. The method of claim 21, wherein the game of chance is electronically played by a player through the Internet.

27. The method of claim 21, wherein the game of chance is electronically purchased by a player through a wireless communication device.

28. The method of claim 21, wherein the game of chance is electronically played by a player through a wireless communication device.

29. The method of claim 21, wherein the game of chance is a video lottery terminal game.

30. The method of claim 21, wherein the game of chance is a stand-alone game.

31. The method of claim 21, wherein the game of chance is an add-on game to a distinct game.

32. The method of claim 31, wherein the distinct game is also a game of chance.

33. The method of claim 31, wherein the distinct game is a game other than a game of chance.

34. The method of claim 1, wherein the game of chance is a casino game.

35. The method of claim 1, wherein the plurality of game of chance entries is a plurality of game of chance paper tickets.

36. The method of claim 35, wherein the game of chance entry generation apparatus is a terminal having a ticket printer.

37. The method of claim 1, wherein the game of chance entry generation apparatus is a video display.

38. The method of claim 37, wherein the video display is operably connected to a terminal at which a game of chance player plays the game of chance.

39. The method of claim 37, wherein the video display is operably connected to a point of sale terminal at which a game of chance player purchases a game of chance entry for the game of chance.

40. A computer program product comprising a computer useable medium having a computer readable program, wherein the computer readable program when executed on a computer causes the computer to:
generate, with a game of chance entry generation apparatus, a plurality of game of chance entries such that (i) each game of chance entry provides a game of chance player with an opportunity to play the game of chance and (ii) the game of chance provides a plurality of offered non-cash prizes such that a cost in cash incurred by a game of chance operator for a plurality of redeemed non-cash prizes, which is a subset of the plurality of offered non-cash prizes, is less than a fair market value of purchasing the plurality of offered non-cash prizes as a result of the cost in cash incurred by the game of chance operator being calculated on a basis of an estimated redemption of the plurality of offered non-cash prizes being less than a full redemption of the plurality of offered non-cash prizes; and
operate, with one or more game operation processors, the game of chance to determine one or more winning outcomes.

41. The computer program product of claim 40, wherein the game of chance has a third party overredemption guarantee that caps the cost in cash incurred by the game of chance operator for the plurality of redeemed non-cash prizes at a cost that is less than the fair market value of purchasing the plurality of offered non-cash prizes.

42. The computer program product of claim 40, wherein the overredemption guarantee is a contract.

43. The computer program product of claim 40, wherein the overredemption guarantee is a third party fulfillment contract.

44. The computer program product of claim 40, wherein the overredemption guarantee is an insurance policy.

45. The computer program product of claim 40, wherein the overredemption guarantee is a bond.

46. The computer program product of claim 40, wherein the overredemption guarantee is a letter of credit.

47. The computer program product of claim 40, wherein the overredemption guarantee is a combination selected from the group consisting of a contract, an insurance policy, a bond, and a letter of credit.

48. The computer program product of claim 40, wherein the fair market value of purchasing the plurality of offered non-cash prizes is the lowest available cost in cash for an unrelated third party purchaser buying, in an arms-length transaction, the plurality of offered non-cash prizes in the same volume as the game of chance operator.

49. The computer program product of claim 40, wherein the game of chance is established without a third party sponsor.

50. The computer program product of claim 40, wherein the game of chance is established with a third party sponsor.

51. The computer program product of claim 50, wherein a sum of the cost in cash incurred by the game of chance operator for a plurality of redeemed non-cash prizes plus a fair market value of advertising, promotional, and other consideration provided by the game of chance operator to the third party sponsor is less than the fair market value of purchasing the plurality of offered non-cash prizes as a result of the cost in cash incurred by the game of chance operator for the plurality of redeemed non-cash prizes being calculated on a basis of the estimated redemption of the plurality of offered non-cash prizes being less than the full redemption of the plurality of offered non-cash prizes.

52. The computer program product of claim 50, further comprising displaying, with a display generation apparatus, an indicator associated with the third party sponsor on one or more game entries for the game of chance.

53. The computer program product of claim 50, wherein the third party sponsor has involvement in supplying the plurality of redeemed non-cash prizes.

54. The computer program product of claim 50, wherein the third party sponsor is a sponsor of the plurality of redeemed non-cash prizes without having involvement in the supplying of the plurality of redeemed non-cash prizes.

55. The computer program product of claim 40, wherein a total potential prize distribution of the plurality of offered non-cash prizes is greater than total potential sales of the plurality of game of chance entries.

56. The computer program product of claim 40, wherein the game of chance also has a plurality of cash prizes.

57. The computer program product of claim 40, wherein a total potential prize distribution of a plurality of offered non-cash prize distributions and a plurality of offered cash prize distributions is greater than total potential sales of the plurality of game of chance entries.

58. The computer program product of claim 57, wherein a quantity of the plurality of game of chance entries available for sale is fixed such that total potential sales of the plurality of game of chance entries are calculated according to a known quantity.

59. The computer program product of claim 56, wherein a quantity of the plurality of game of chance entries available for sale is variable such that total potential sales of the plurality of game of chance entries are calculated according to an estimated quantity.

60. The computer program product of claim 40, wherein the game of chance is a lottery game.

61. The computer program product of claim 60, wherein the game of chance is an instant lottery game such that play indicia for a game of chance player are predetermined and generated prior to purchase at a point of sale.

62. The computer program product of claim 60, wherein the game of chance is a terminal generated game such that play indicia for a game of chance player are generated at a terminal at a point of sale.

63. The computer program product of claim 60, wherein the game of chance is an interactive game that, through a computing device, is electronically purchased and electronically played by a game of chance player.

64. The computer program product of claim 60, wherein the game of chance is electronically purchased by a player through the Internet.

65. The computer program product of claim 60, wherein the game of chance is electronically played by a player through the Internet.

66. The computer program product of claim 60, wherein the game of chance is electronically purchased by a player through a wireless communication device.

67. The computer program product of claim 60, wherein the game of chance is electronically played by a player through a wireless communication device.

68. The computer program product of claim 60, wherein the game of chance is a video lottery terminal game.

69. The computer program product of claim 60, wherein the game of chance is a stand-alone game.

70. The computer program product of claim 60, wherein the game of chance is an add-on game to a distinct game.

71. The computer program product of claim 70, wherein the distinct game is also a game of chance.

72. The computer program product of claim 70, wherein the distinct game is a game other than a game of chance.

73. The computer program product of claim 40, wherein the game of chance is a casino game.

74. The computer program product of claim 40, wherein the plurality of game of chance entries is a plurality of game of chance paper tickets.

75. The computer program product of claim 74, wherein the game of chance entry generation apparatus is a terminal having a ticket printer.

76. The computer program product of claim 40, wherein the game of chance entry generation apparatus is a video display.

77. The computer program product of claim 76, wherein the video display is operably connected to a terminal at which a game of chance player plays the game of chance.

78. The computer program product of claim 76, wherein the video display is operably connected to a point of sale terminal at which a game of chance player purchases a game of chance entry for the game of chance.

79. A system comprising:
a game of chance entry generation apparatus that generates a plurality of game of chance entries such that (i) each game of chance entry provides a game of chance player with an opportunity to play the game of chance and (ii) the game of chance provides a plurality of offered non-cash prizes such that a cost in cash incurred by a game of chance operator for a plurality of redeemed non-cash prizes, which is a subset of the plurality of offered non-cash prizes, is less than a fair market value of purchasing the plurality of offered non-cash prizes as a result of the cost in cash incurred by the game of chance operator being calculated on a basis of an estimated redemption of the plurality of offered non-cash prizes being less than a full redemption of the plurality of offered non-cash prizes; and
one or more game operation processors that operate the game of chance to determine one or more winning outcomes.

80. The system of claim 79, wherein the game of chance has a third party overredemption guarantee that caps the cost in cash incurred by the game of chance operator for the plurality of redeemed non-cash prizes at a cost that is less than the fair market value of purchasing the plurality of offered non-cash prizes.

81. The system of claim 79, wherein the overredemption guarantee is a contract.

82. The system of claim 79, wherein the overredemption guarantee is a third party fulfillment contract.

83. The system of claim 79, wherein the overredemption guarantee is an insurance policy.

84. The system of claim 79, wherein the overredemption guarantee is a bond.

85. The system of claim 79, wherein the overredemption guarantee is a letter of credit.

86. The system of claim 79, wherein the overredemption guarantee is a combination selected from the group consisting of a contract, an insurance policy, a bond, and a letter of credit.

87. The system of claim 79, wherein the fair market value of purchasing the plurality of offered non-cash prizes is the lowest available cost in cash for an unrelated third party purchaser buying, in an arms-length transaction, the plurality of offered non-cash prizes in the same volume as the game of chance operator.

88. The system of claim 79, wherein the game of chance is established without a third party sponsor.

89. The system of claim 79, wherein the game of chance is established with a third party sponsor.

90. The system of claim 89, wherein a sum of the cost in cash incurred by the game of chance operator for a plurality of redeemed non-cash prizes plus a fair market value of advertising, promotional, and other consideration provided by the game of chance operator to the third party sponsor is less than the fair market value of purchasing the plurality of offered non-cash prizes as a result of the cost in cash incurred by the game of chance operator for the plurality of redeemed non-cash prizes being calculated on a basis of the estimated redemption of the plurality of offered non-cash prizes being less than the full redemption of the plurality of offered non-cash prizes.

91. The system of claim 89, further comprising displaying, with a display generation apparatus, an indicator associated with the third party sponsor on one or more game entries for the game of chance.

92. The system of claim 89, wherein the third party sponsor has involvement in supplying the plurality of redeemed non-cash prizes.

93. The system of claim 89, wherein the third party sponsor is a sponsor of the plurality of redeemed non-cash prizes without having involvement in the supplying of the plurality of redeemed non-cash prizes.

94. The system of claim 79, wherein a total potential prize distribution of the plurality of offered non-cash prizes is greater than total potential sales of the plurality of game of chance entries.

95. The system of claim 79, wherein the game of chance also has a plurality of cash prizes.

96. The system of claim 95, wherein a total potential prize distribution of a plurality of offered non-cash prize distributions and a plurality of offered cash prize distributions is greater than total potential sales of the plurality of game of chance entries.

97. The system of claim 95, wherein a quantity of the plurality of game of chance entries available for sale is fixed such that total potential sales of the plurality of game of chance entries is calculated according to a known quantity.

98. The system of claim 95, wherein a quantity of the plurality of game of chance entries available for sale is variable such that total potential sales of the plurality of game of chance entries is calculated according to an estimated quantity.

99. The system of claim 79, wherein the game of chance is a lottery game.

100. The system of claim 99, wherein the game of chance is an instant lottery game such that play indicia for a game of chance player are predetermined and generated prior to purchase at a point of sale.

101. The system of claim 99, wherein the game of chance is a terminal generated game such that play indicia for a game of chance player are generated at a terminal at a point of sale.

102. The system of claim 99, wherein the game of chance is an interactive game that, through a computing device, is electronically purchased and electronically played by a game of chance player.

103. The system of claim 99, wherein the game of chance is electronically purchased by a player through the Internet.

104. The system of claim 99, wherein the game of chance is electronically played by a player through the Internet.

105. The system of claim 99, wherein the game of chance is electronically purchased by a player through a wireless communication device.

106. The system of claim 99, wherein the game of chance is electronically played by a player through a wireless communication device.

107. The system of claim 99, wherein the game of chance is a video lottery terminal game.

108. The system of claim 99, wherein the game of chance is a stand-alone game.

109. The system of claim 99, wherein the game of chance is an add-on game to a distinct game.

110. The system of claim 109, wherein the distinct game is also a game of chance.

111. The system of claim 109, wherein the distinct game is a game other than a game of chance.

112. The system of claim 79, wherein the game of chance is a casino game.

113. The system of claim 79, wherein the plurality of game of chance entries is a plurality of game of chance paper tickets.

114. The system of claim 113, wherein the game of chance entry generation apparatus is a terminal having a ticket printer.

115. The system of claim 79 wherein the game of chance entry generation apparatus is a video display.

116. The system of claim 115, wherein the video display is operably connected to a terminal at which a game of chance player plays the game of chance.

117. The system of claim 115, wherein the video display is operably connected to a point of sale terminal at which a game of chance player purchases a game of chance entry for the game of chance.
